(19) United States
(12) Patent Application Publication
(10) Pub. No.: US 2025/0013869 A1
(43) Pub. Date: Jan. 9, 2025

(54) TRAINING NEURAL NETWORKS ON ARBITRARILY LARGE DATA FILES

(71) Applicant: SRI International, Menlo Park, CA (US)

(72) Inventors: John Cadigan, San Diego, CA (US); Dayne Brian Freitag, Descanso, CA (US); John Joseph Niekrasz, Bonita, CA (US); Chih-hung Yeh, Alameda, CA (US)

(21) Appl. No.: 18/762,333

(22) Filed: Jul. 2, 2024

Related U.S. Application Data
(60) Provisional application No. 63/524,817, filed on Jul. 3, 2023.

(51) Int. Cl. G06N 3/084

(52) U.S. Cl. CPC G06N 3/084

(57) ABSTRACT

In an example, a method for a method for training a Machine Learning (ML) model using arbitrarily sized training data files, to selectively identify informative portions of one or more training data files for improving the ML model includes automatically selectively identifying, by a computing system, one or more informative portions of one or more training data files; calculating, by the computing system, gradients for the identified one or more informative portions; and updating, by the computing system, weights of a ML model using the calculated gradients.

This application claims the benefit of U.S. Patent Application 63/524,817, filed Jul. 3, 2023, which is incorporated by reference herein in its entirety.

### GOVERNMENT RIGHTS

This invention was made with Government support under grant number 49100422C0013 awarded by the National Science Foundation. The Government has certain rights in this invention.

### TECHNICAL FIELD

This disclosure is related to machine learning systems, and more specifically to training neural networks on arbitrarily large data with performance guarantees.

### BACKGROUND

Existing machine learning models could be trained on arbitrary sized documents or videos. Ideally such models could handle data of any length, such as, but not limited to, a very long document or an extremely long video or collection of videos. Handling arbitrary size documents or videos would be advantageous because it may allow the machine learning model to learn from a wider range of information. However, training such machine learning models on massive data sets is often impractical due to limitations with current computer hardware. Processing massive amounts of data may require significant processing power, memory, and storage space. Even with powerful hardware, training the machine learning model may take a very long time.

### SUMMARY

In general, techniques are described for training machine learning models on arbitrarily sized training data files, in some cases with fixed memory usage. Traditional classification models often struggle with extremely large training data files, such as very long documents, videos, or audio files. As the size of an input training data file increases, so does the memory required to process it, and the required memory can in some cases reach or exceed available hardware resources. In some examples, instead of processing the entire training data file at once, the disclosed techniques may extract and analyze informative excerpts. The term “informative excerpts,” as used herein refers to the relevant and valuable parts of a training dataset for model training. By limiting the analysis to selected informative excerpts that can be processed using a constrained amount of memory, the memory footprint may satisfy the constraint regardless of the overall size of the data file. The training process may include providing training data in a form of a plurality of informative excerpts and then training the model to select informative excerpts.

The effectiveness of the disclosed techniques may depend on the quality of the excerpt selection process. Choosing informative excerpts that better capture the important aspect(s) or meaning(s) of a training data file may be important for accurate classification, and techniques are described for excerpt selection. There may be a trade-off between accuracy and efficiency for excerpt selection. Using fewer or shorter excerpts may reduce processing time but could also lead to less accurate classification. In some examples, the techniques include balancing accuracy and efficiency by the machine learning system.

The disclosed techniques may perform an initial analysis of an entire training data file without calculating gradients (values used for training). The disclosed techniques may start with randomly chosen parameters. The entire training dataset may be analyzed without calculating gradients. Gradients are values used to update the model parameters during training. A machine learning system comprising a selector model may aim to find the “top k” most informative pieces of data (excerpts). These excerpts could be specific data points, sections of text documents, or certain image features, depending on the data type. The informative excerpts identified earlier may be used to train a selector model.

Backpropagation is a technique used in neural networks where the error is propagated backward, allowing the model to adjust its internal parameters and improve its selection process. As described herein, a machine learning system may process the data with the classification model twice, for different purposes in each pass. There is a limit on how much memory the machine learning system may use, which is tied to the memory usage of the initial processing/analysis step. The configurable memory constraint may ensure efficiency or the ability to handle large datasets on limited hardware.

The techniques may provide one or more technical advantages that realize at least one practical application. For example, the disclosed techniques may allow a machine learning system to handle training data files of arbitrary size without exceeding memory constraints. Processing smaller excerpts may in some cases be faster than processing the entire training data file, which may improve efficiency as well. In some cases, the final classification (e.g., assigning a category to the data) is explainable. The classification model may highlight specific subsets of the data that contribute to the decision, making the classification model more transparent than a “black box” model over a long input.

In an example, a method for training a Machine Learning (ML) model using arbitrarily sized training data files, to selectively identify informative portions of one or more training data files for improving the ML model includes automatically selectively identifying, by a computing system, one or more informative portions of one or more training data files; calculating, by the computing system, gradients for the identified one or more informative portions; and updating, by the computing system, weights of a ML model using the calculated gradients.

In an example, a method for classifying data files includes obtaining one or more arbitrarily sized data files; and classifying the one or more arbitrarily sized data files using a classification model trained to classify arbitrarily sized data files according to a memory size constraint.

In an example, a computing system for training a Machine Learning (ML) model, using arbitrarily sized training data files, to selectively identify informative portions of one or more training data files for improving the ML model, the computing system includes: processing circuitry in communication with storage media, the processing circuitry configured to execute a machine learning system configured to: automatically selectively identify one or more informative portions of one or more training data files; calculate gradients for the identified one or more informative portions; and update weights of a ML model using the calculated gradients.

In an example, non-transitory computer-readable storage media having instructions encoded thereon, the instructions configured to cause processing circuitry to: automatically selectively identify one or more informative portions of one or more training data files; calculate gradients for the identified one or more informative portions; and update weights of a machine learning model using the calculated gradients.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating a classification system, in accordance with the techniques of the disclosure.

FIG. 2 is a detailed block diagram illustrating an example computing system, in accordance with the techniques of the disclosure.

FIG. 3 illustrates selection of textual excerpts, in accordance with the techniques of this disclosure.

FIG. 4 is a conceptual diagram illustrating double pass max pooling, in accordance with the techniques of the disclosure.

FIG. 5 is a conceptual diagram illustrating alternative textual excerpts selection strategies, in accordance with the techniques of the disclosure.

FIG. 6 is a flowchart illustrating an example mode of operation for a machine learning system, according to techniques described in this disclosure.

Like reference characters refer to like elements throughout the figures and description.

### DETAILED DESCRIPTION

Powerful machine learning models often struggle with processing very large data, such as extremely long documents or lengthy videos. As the size of the data increases, the amount of memory required to process the data also grows because neural networks typically store intermediate activations to calculate gradients. Such increase may quickly reach the limitations of current hardware, hindering the ability to train and use such machine learning models on massive datasets. The disclosed techniques provide a new architecture and training procedure specifically designed to overcome the aforementioned memory limitation. The disclosed techniques may allow the machine learning system to scale to data files of any size (arbitrary sized) while keeping the memory usage fixed (does not increase with data file size). The disclosed techniques open the door to training machine learning models on much larger datasets, potentially leading to improved performance and accuracy. The ability to handle arbitrary sized data files may expand the applicability of the models to a wider range of real-world scenarios.

As noted above, as data file length increases, so does the memory needed to process the data file all at once, eventually reaching hardware limitations. The disclosed system may identify and analyze informative excerpts from the data file instead of processing the entire data file. Focusing on informative parts may significantly reduce the amount of data requiring immediate memory during classification. An additional step may be added to the training process specifically for selecting these informative excerpts. The excerpt selection step may be important for accurate classification, as the selection step ensures the chosen excerpts capture the essence of the data file. By limiting the analysis to a fixed-size set of excerpts, the memory footprint may remain constant regardless of the overall data file length. Fixed memory usage may allow the machine learning system to handle data files of any size (arbitrarily long) without memory constraints. Processing smaller excerpts may be faster than processing the entire data file, potentially improving classification efficiency. The effectiveness of the disclosed techniques may hinge on the quality of the excerpt selection process. Choosing informative excerpts that accurately represent the data file may be important for maintaining good classification accuracy. The specific model architecture used for classifying the excerpts may also impact performance. Some machine learning models may be better suited for handling short snippets of text compared to others.

Gradient checkpointing may reduce memory usage during backpropagation (training phase). Backpropagation may require storing all intermediate activations (outputs from each layer) which may consume a lot of memory. Gradient checkpointing may store only a subset of activations strategically, and may recompute the missing ones on-demand during backpropagation. Gradient checkpointing may use less memory compared to storing all activations. However, recomputing activations may add extra computational overhead, potentially slowing down training.

Gradient checkpointing does not perform two complete forward passes, but the gradient checkpointing may require recomputing parts of the forward pass during backpropagation. Gradient checkpointing does not address data size limitations. The entire training data file may still be processed, potentially exceeding memory limits for massive data. Similar to gradient checkpointing, the disclosed techniques may aim to overcome memory limitations when classifying very large training data files. However, the disclosed techniques focus on informative excerpts from data file instead of processing the entire training data file at once. The disclosed techniques may significantly reduce memory usage as only excerpts are loaded into memory at a time.

Advantageously, memory footprint may remain constant regardless of the size of the training data file. Gradient checkpointing reduces memory by manipulating how activations are handled during backpropagation. The disclosed techniques may reduce memory by focusing on a smaller subset of the data (excerpts) from the beginning. Gradient checkpointing does not directly address data size limitations. The disclosed techniques may inherently handle files of any size by processing excerpts.

The challenge is to find the most informative excerpts from a large training file for classification while keeping memory usage in check. The disclosed system may perform an initial analysis of the entire training file without calculating gradients, as described below.

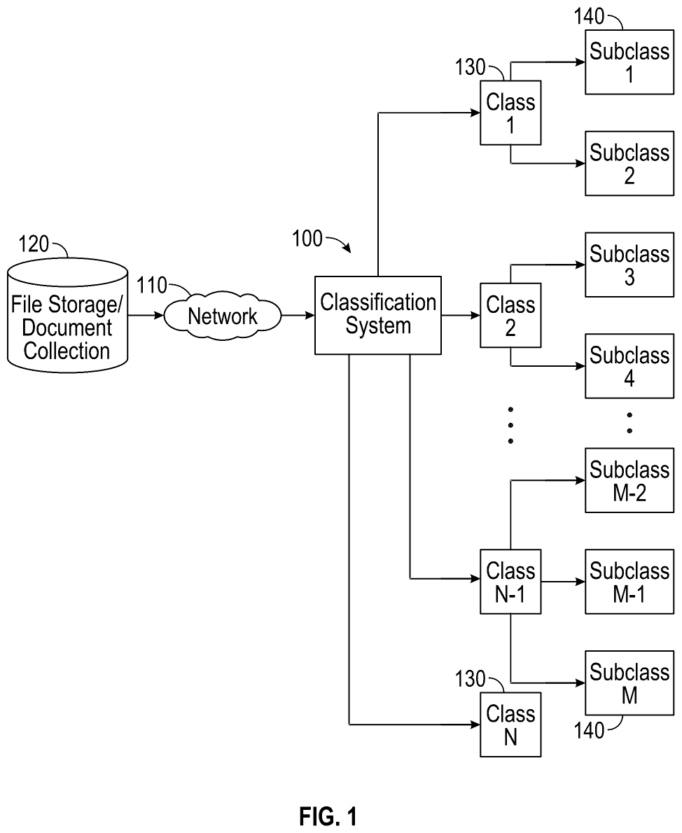

Referring now to the drawings in which like numerals represent the same or similar elements, FIG. 1 represents a conceptual overview of a classification system 100 or N-classifier system. Classification system 100 may solve a classification problem by classifying data files from data file collection 120 as members of any number of classes 130 or subclasses 140 as defined in a classification problem. Subclasses 140 may also have additional subclasses, thus creating a multi-level hierarchy of classes and subclasses. A classification problem may require any number of classes 130 and/or subclasses 140 in which to sort or classify a data file from data file collection 120. A data file in data file collection 120 may be classified as a member of any number of classes 130 or subclasses 140 defined for a classification problem. A classification problem may define N−1 classes 130 with each class representing a mapping to a concept of a classification problem. For example, in the context of e-discovery, in which the data files are documents, class 1 might represent the set of documents that are related to the issue of liability in a litigation, while class 2 might represent the set of documents potentially relevant to the issue of remedies. A subclass 1 of class 1 might further classify documents as potentially relevant to monetary damages, while subclass 2 of class 1 might further classify documents as potentially relevant to injunctive relief. In this example, classes 1 through (N−1) represent the set of documents that are considered potentially relevant to a classification problem, and class N may represent the set of documents considered non-relevant to the classification problem (e.g., the null set). In its simplest form, a classification problem may be defined to have only two classes: class 1—relevant and class 2—non-relevant. Alternatively, for any particular class X, the set of data files Y that are not a member of class X may be considered as the set of data files non-relevant to class X. A data file from data file collection 120 may be any multimodal information that may be stored in any electronic format including a word-processing file, spreadsheet, email, scientific paper, literary works, training file, company document, text message, contact list, calendar entry, HTML file, image file, video file, audio file, source code, object code, post-script file, or a digital version of a physical data file. A data file from data file collection 120 may be any collection of information that is discretely identifiable or representable.

In other words, a data file from data file collection 120 may incorporate information beyond just text. In addition to text processing techniques like keyword extraction or sentence embedding, classification system 100 may employ methods to handle other data types. Techniques like image recognition may identify objects, scenes, or actions depicted in images. Speech recognition techniques may transcribe spoken content, while audio analysis may identify emotions or music genres. In some examples. Classification system 100 may combine information from different modalities. For example, informative excerpts in text may be used to understand the context of an image, or sentiment analysis of text may be supplemented by analyzing the tone of the speaker in audio data.

In an example, classification system 100 may obtain a data file having an arbitrary size from data file collection 120 via any type of a general or specific communication network 110. Communication network 110 may be any communication network, including any wired and/or wireless communication technologies, wired and/or wireless communication protocols, and the like. Communication network 110 may be any communication network that communicatively couples a plurality of computing devices and storage devices in such a way as to computing devices to exchange information via communication network 110. Classification system 100 may selectively identify informative portions of the obtained data file. This step may involve identifying the parts of the data file that are relevant for a particular classification task. In an example, classification system 100 may use pre-trained models to convert each informative portion into a numerical representation that captures the meaning of the corresponding informative portion. Classification system 100 may then select the informative portions with high scores based on the particular classification task. Advantageously, classification system 100 may only store the identified informative portions in a memory of a fixed size. Classification system 100 may include an initial classification model based on a pre-trained language model. The classification model may take an input (raw text) and may predict a class label (e.g., spam/not spam, sentiment analysis, and the like). Classification system 100 may feed the informative portions (represented as feature vectors) into the classification model. Classification system 100 may calculate the difference between the predicted class and the actual class (if known during training). Classification system 100 may use a backpropagation algorithm to calculate the gradients based on this difference. Backpropagation works its way back through the layers of the classification model, assigning blame (gradients) to each weight of the classification model for the prediction error. Classification system 100 may use the calculated gradients to update the weights of the classification model in a direction that minimizes the prediction error. By iteratively processing data files, identifying informative portions, calculating gradients, and updating weights, the disclosed classification model may learn from the data and may improve its ability to classify new data files in the data file collection 120.

While described with respect to a particular examples of classification, the techniques of this disclosure may be applied to classification models in a variety of applications, such as other applications of classification or regression, natural language processing (NLP), computer vision and others.

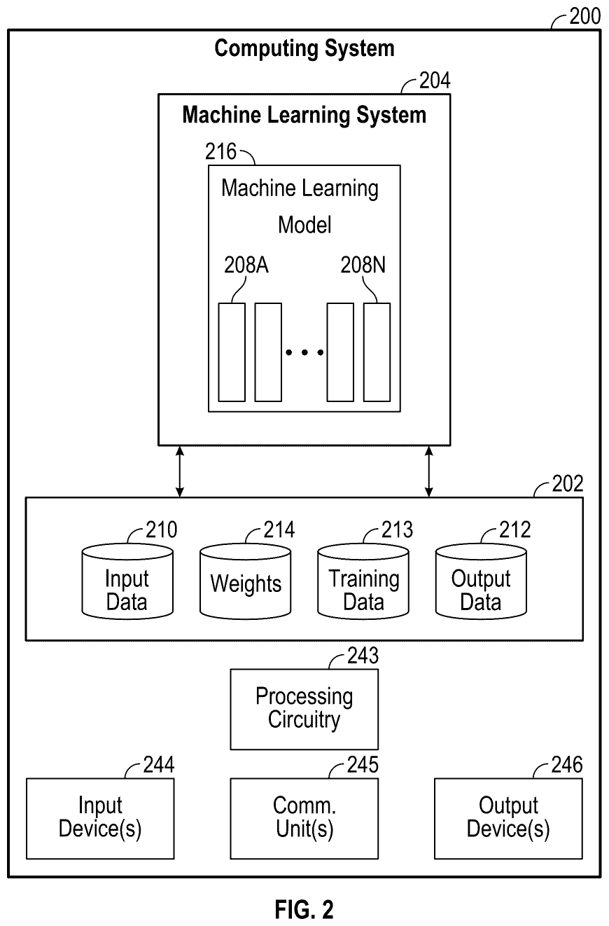

FIG. 2 is a block diagram illustrating an example computing system 200. In an aspect, computing system 200 may represent classification system 100 shown in FIG. 1. As shown, computing system 200 includes processing circuitry 243 and memory 202 for executing a machine learning system 204 having a machine learning model 216 comprising a set of layers 208A-208N (collectively, “layers 208”).

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., machine learning model 216), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 204 may receive input data from an input data set 210 and may generate output data 212. Input data 210 and output data 212 may contain various types of information, which will generally be tailored to the application/use case for the classification models. When used in the example system of FIG. 1, input data 210 may include a data file from data file collection 120, a classification problem, and the like. Other types of input data 210 may include various types of text including documents, social media posts, emails, or transcripts; financial data; multi-modal data; and so forth. Output data 212 may include information such as, but not limited to, classification of the data file as a member of any number of classes 130 or subclasses 140 defined for a classification problem, most informative excerpts, and the like.

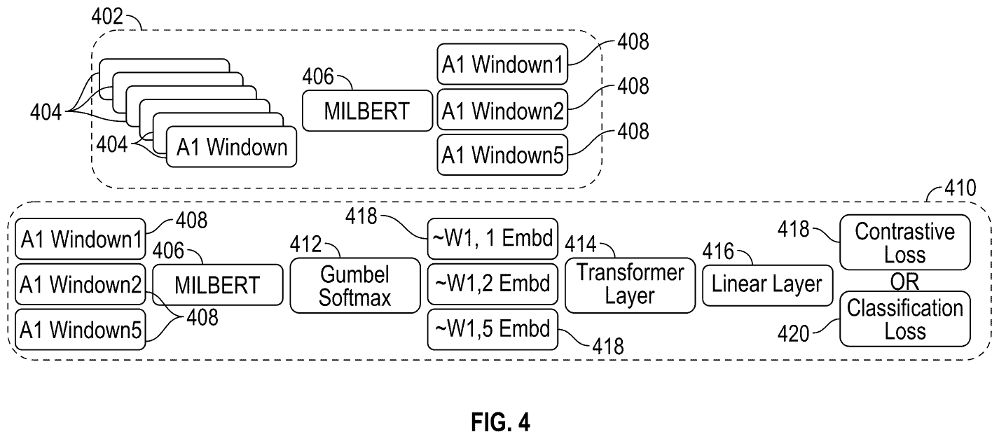

Set of layers 208 may include a respective set of artificial neurons. Layers 208 for example, may include an input layer, an output layer, and one or more hidden layers. Layers 208 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer. In an example, layers 208 may include at least a transformer layer and linear layer shown in FIG. 4.

Machine learning system 204 may process training data 213 to train the classification models, in accordance with techniques described herein. For example, machine learning system 204 may apply an end-to-end training method that includes processing training data 213. Training data 213 may include, but is not limited to, classification of the excerpts selected from the input data file. As other examples, training data 213 may come in the form of “bags” representing a collection of items. In some cases, the labels may be only assigned to the entire bag, not to individual instances within the bag. In other cases, individual instances could have labels but only if the bag has a label. Once trained, machine learning model 216 may be deployed to process input data 210 from the data file collection 120 shown in FIG. 1. In an example, most informative excerpts generated by the machine learning model 216 may be analyzed to interpret classification decisions.

As noted above, conventional data file classification models may struggle with large data files due to increasing memory demands. As the size of the data file increases, the amount of data machine learning model 216 needs to process at once also grows. The amount of needed data may quickly exceed available memory 202, hindering the ability of the machine learning model 216 to learn effectively. Machine learning system 204 may address the aforementioned issue by making two forward passes on the data. During the first pass, machine learning system 204 may analyze the entire data file without calculating gradients to identify the top k most informative excerpts. Machine learning system 204 may focus exclusively on informative excerpts instead of processing the entire data file at once. Such focus may significantly reduce the amount of data required in memory 202 during training and classification.

Advantageously, during the second pass, machine learning system 204 may focus on only the top k excerpts for detailed analysis and gradient calculation. The disclosed techniques may keep the memory usage constrained to a fixed value (k times the memory usage of the encoder) regardless of the data file size. In one non-limiting example, “encoder” refers to the part of the machine learning model 216 that processes the input data (data files in this case).

As used herein, “k” may be a constant value that determines the memory footprint. In an aspect, machine learning system 204 may handle data files of any size (arbitrarily large) without memory limitations. A nice byproduct of the disclosed techniques is that the classification decision may become interpretable, as described below.

In an example, by focusing on the top k excerpts, the machine learning system 204 may essentially highlight the parts of the data file that most influenced the classification. In other words, the disclosed techniques may provide valuable insights into the reasoning of the machine learning model 216.

In one non-limiting example, by allowing machine learning model 216 to learn from much larger datasets, machine learning system 204 may potentially achieve better classification accuracy. The ability to handle data files of any size may expand the potential applications of machine learning system 204 to real-world scenarios that often involve massive datasets (e.g., legal documents, medical records, long surveillance videos, user behavior classification).

As noted above, the machine learning system 204 may perform an initial analysis of the entire data file without calculating gradients. In an aspect, machine learning system 204 may perform the first pass to identify the top k most informative excerpts. Machine learning system 204 may focus its attention on only the top k excerpts identified in the first pass. In the example illustrated in FIG. 4, since only the identified top k excerpts are used by machine learning system 204 to calculate the gradients needed for training, the disclosed technique recalls max pooling but is distinct in several ways. During processing, each layer in a neural network may generate intermediate outputs called activations. The intermediate activations may hold temporary values that contribute to the final output of the neural network. Operating over at least 1 dimension, traditional max pooling layers return the maximum value for activations over sections of the input. It is possible for maximum values to come from an unconstrained portion of the file. By contrast double pass pooling, picks a selected number of excerpts from which to gather values. If the machine learning system 204 encoded excerpts with a 32-dimensional vector and applied max pooling, it would select the maximum value from each dimension across all the encoded excerpts. This encoding would result in a single 32-dimensional vector representing the entire dataset. Max pooling typically involves calculating gradients for all elements in the input data to determine the maximum value. In this case, calculating gradients for every encoded excerpt (potentially thousands or millions) would be computationally expensive and unnecessary. In contrast the second pass of the double pass pooling may focus on the K selected excerpts. This may result in K 32-dimensional vectors, capturing the most informative excerpts while significantly reducing the amount of data processed and gradients calculated.

When processing large data files, neural networks, such as, but not limited to, machine learning model 216 may generate a large volume of intermediate activations. Storing all the intermediate activations for a large data file may consume a significant amount of memory. This may become a major bottleneck when training neural networks on very large datasets or individual documents, as memory limitations may hinder the training process. For example, storing all intermediate activations may lead to memory limitations (OOM—Out Of Memory errors) for long documents. The disclosed two-pass approach avoids storing all activations. The machine learning system 204 may discard the less relevant information after the first pass and may focus only on the top k excerpts in the second pass, significantly reducing memory usage. Essentially, machine learning system 204 may act as a filter. Machine learning system 204 may first skim through the entire data file to identify the most promising areas (top k excerpts) in the first pass (without gradients). Then, machine learning system 204 may zoom in on those areas for detailed analysis (second pass with gradients) to improve its selection criteria.

The aforementioned filtering process may help achieve the benefits of max pooling (focusing on the most informative parts) without the memory overhead associated with traditional max pooling implementations.

The core idea of the disclosed techniques-focusing on informative excerpts-could be applied beyond just data file classification. The disclosed techniques may be used with a Mixture of Experts (MoE) architecture to potentially train even larger models. MoE architecture is a specific type of neural network architecture where the work may be divided among multiple “expert” sub-networks. In standard neural networks, all parts of the network are typically active during processing. Standard neural networks may be inefficient if different parts of the network are better suited for specific situations within a task. Gating mechanisms may introduce a level of control within a neural network. The gating mechanisms may act like gates that can activate or deactivate different sub-networks within the overall MoE architecture. In an example, a network may have multiple “experts” (sub-networks) each specializing in a particular aspect of a task.

The main network (gating network) may determine which expert(s) to use for a particular input data point. In many cases, by combining the disclosed excerpt-based techniques with MoE, machine learning system 204 could potentially train even larger and more complex models.

MoE architectures may improve efficiency by allowing the network of machine learning models to focus on the most relevant experts for a specific task.

The disclosed techniques are not limited to just any large data file classification task. Machine learning system 204 may be particularly well-suited for problems where the final classification decision may be made by analyzing a relevant subset of the data. In data file classification, the key information for classification may be contained within specific sections or passages, rather than the entire data file. Machine learning system 204 may efficiently identify these informative passages and may use them for accurate classification. Conventional classification models may classify a single item (text, image, etc.) into a predefined category. The disclosed techniques may also be applied to authorship verification problems. Authorship verification may compare two pieces of writing (documents or document sets) to determine if they share the same author. For example, such verification model may analyze a newly discovered manuscript to see if it matches the writing style of a known author. Classification models often need a wider variety of training data encompassing different categories. Verification models may be more focused on analyzing writing styles and patterns.

Similarly, in video classification, the important moments for understanding the content may be concentrated in a few key clips. Machine learning system 204 may focus on identifying and analyzing these key clips to determine the category of the video. Several techniques may be used to identify informative video clips. Scene detection may involve segmenting the video into shots or scenes with similar visual characteristics including, but not limited to, camera angles or background changes. Machine learning system 204 may identify and track objects such as, but not limited to, people, animals, or specific objects of interest throughout the video. Object detection/tracking may help pinpoint relevant scenes. Action recognition technique may identify specific actions happening in the video, such as someone cooking, giving a presentation, or playing a sport. Machine learning system 204 may use speech recognition to identify spoken content within the video, while audio analysis may detect changes in sound like music or crowd noise, potentially highlighting informative clips.

As noted above, the strength of the disclosed machine learning system 204 may lie in its ability to identify informative excerpts from large data. Such focus on excerpts may directly align with the idea of making decisions based on relevant subsets. By focusing on excerpts, machine learning system 204 may avoid processing the entire data file (e.g., long text or video), leading to efficiency gains and potentially faster classification. Classifying data files or reviews based on sentiment (positive, negative, neutral) may often be possible by analyzing key phrases or sentences instead of the entire text. Identifying key moments or highlights from a video can be achieved by focusing on informative clips, which may align with the disclosed techniques. Classifying emails as spam or not-spam may potentially be done by analyzing specific elements like sender information, subject line, or keywords, rather than the entire email body.

The machine learning system 204 may perform an initial analysis of the entire data file using the machine learning model 216. However, machine learning system 204 does not calculate gradients during this pass. Such non-gradient analysis may help save memory.

Machine learning system 204 may use a modified max pooling layer described below of the machine learning model 216 to identify the most informative excerpts for the entire data file.

The modified max pooling layer may essentially select the elements with the highest values in a specific region. In an example, max pooling layer may select the most informative parts (excerpts) based on the initial (non-gradient) analysis. In one example, the second step may involve machine learning system 204 performing a “normal” forward pass with the machine learning model 216. As used herein, the term “normal” may signify that gradients (used for training) may be calculated in this pass, unlike the first pass. This forward pass may be performed on the previously identified excerpts from the first step, not the entire data file. Such technique may significantly reduce the amount of data the machine learning model 216 needs to process at once.

The identified informative portions (excerpts) may be converted into a format the machine learning model 216 can understand. Such format may include a feature vector (representing word frequencies, topics, or key points) or another compressed representation of the identified excerpts. The converted informative portions (feature vector or compressed representation) may be fed as input to the pre-trained machine learning model 216. Machine learning model 216 may utilize its internal layers 208 and weights 214 to analyze the provided features. These features may capture the essence of the data file based on the selected informative excerpts. Based on the analysis of these features, machine learning model 216 may predict a class label for the data file. This class label may represent categories (e.g., classes 130 shown in FIG. 1) like sentiment (positive/negative), topic (business/sports), or spam/not spam.

Next, machine learning system 204 may perform a standard backpropagation step. As noted above, backpropagation works its way back through the layers 208 of the machine learning model 216, assigning blame (gradients) to each weight of the classification model for the prediction error. Classification system 100 may use the calculated gradients to update the weights 214 of the machine learning model 216 in a direction that minimizes the prediction error. Machine learning system 204 may calculate the gradients based on the classification error and the model output (e.g., class label) of the machine learning model 216 for the excerpts. In other words, machine learning system 216 may use the calculated gradients to update the weights 214 of the machine learning model 216, essentially allowing the machine learning model 216 to learn from the analysis of the informative excerpts. The machine learning model 216 might sometimes make mistakes. The term “classification error” refers to the difference between the prediction of machine learning model 216 on an informative excerpt and the actual correct classification. The classification error may indicate how well machine learning model 216 performed on that specific informative excerpt. The term “model output” refers to the actual prediction machine learning model 216 made on the informative excerpt. The model output could be a probability score for different categories (e.g., 80% chance of being relevant, 20% chance of being irrelevant) or a direct classification label (e.g., “important”). Gradients, in machine learning, may indicate how much a change in one value (e.g., weights 214 of the machine learning model 216) may affect another value (e.g., the classification error). In an example, machine learning system 204 may calculate the gradients with respect to two things: classification error and the model output. By calculating the gradient of the error with respect to the weights 214 of the machine learning model 216, machine learning system 204 may adjust those weights to minimize future errors on informative excerpts. Calculating the gradient of the model output with respect to weights 214 may help machine learning system 204 to adjust machine learning model 216 to better identify the informative excerpts and classify the corresponding data files.

In summary, the first step of the disclosed technique may efficiently identify informative excerpts using a memory-saving approach. The second step may focus on the detailed analysis on the identified excerpts. The third step may ensure machine learning model 216 learns and updates its weights 214 based on the performed analysis.

It should be noted that standard max pooling layers are commonly used to identify the most informative parts of a data file. However, one of the drawbacks is that the max pooling layers typically store all intermediate activations from the entire data file.

The aforementioned challenge with max pooling layers may lead to memory limitations, especially for very large data files. In an example, the described herein modification of the max pooling architecture may specifically address the memory usage issue. The machine learning system 204 may focus exclusively (only) on the informative excerpts identified during the first pass (using max pooling or a similar technique). Since the machine learning system 204 may discard parts of the data file that are not selected as excerpts, the gradients for those parts may be essentially zero.

By not needing to store or calculate gradients for unused parts, machine learning system 204 may significantly reduce memory usage compared to traditional max pooling. Conventional training methods do not know which parts of the data file will be discarded beforehand. Therefore, the conventional training methods may calculate and store intermediate activations for the entire data file, leading to memory limitations for large data files. In an example, the disclosed techniques may be implemented in a streaming fashion. In an example, in the alternative implementation, machine learning system 204 may process the data file in parts, identifying informative sections and updating the machine learning model 216 on the fly. By releasing memory 202 as processing progresses, machine learning system 204 could potentially eliminate the need for two separate passes.

Generally, assigning labels (correct classifications) to data may be costly. For example, identifying cancerous cells in whole slide images may require expertise and time from medical professionals. Some labels may be inherently difficult to assign definitively due to ambiguity or lack of clear indicators. An example of such elusive labeling may be identifying gender of an author based on writing style. While some words or excerpts may be suggestive, such words are not necessarily conclusive.

Training complex models on massive datasets may require significant computational resources, making them expensive. In one implementation, the disclosed machine learning system 204 may implement a Multiple Instance Learning (MIL) technique that may focus on classifying sets of data points (bags) based on the most positive instances within the bag. MIL is a machine learning technique used for classification problems where the training data comes in the form of “bags” containing multiple instances, but the labels may be only assigned to the entire bag, not to individual instances within the bag. A bag may represent a collection of items. In MIL, these bags may represent the data points that the machine learning system 204 is working with. Each item within a bag is called an instance. Unlike traditional supervised learning where each data point has its own label, in MIL, the label may be assigned to the entire bag. In other words, machine learning system 204 may know something about the bag as a whole, but the machine learning system 204 may not necessarily know which specific instances in the bag contribute to that classification. In one non-limiting example, a bag could be a collection of webpages related to a specific topic. The bag might be labeled as “sports news” if at least one webpage within the bag discusses sports news, even if other webpages cover different topics. For example, by analyzing the “best” examples within the bag, machine learning system 204 may be able to achieve good classification accuracy without requiring extensive labeling for every single data point. Additionally, focusing on the most informative instances could potentially lead to more explainable classifications. Machine learning model 216 may highlight the key data points that contributed most to the classification decision, providing insights into reasoning of the machine learning model 216.

In an example, by focusing on labeling the most informative instances, machine learning system 204 may reduce the overall labeling effort, making the process more efficient and cost-effective. The disclosed techniques may be more robust to data with inherent ambiguity (like author gender based on writing style). In an example, the machine learning model 216 may learn from the most indicative features within the bag without requiring a definitive label for every data point. Focusing on a subset of data points within the bag could potentially lead to faster training times and lower computational resource requirements compared to training machine learning model 216 on the entire dataset.

An advantage of such technique is that highlighting the most informative instances that influenced the classification decision may provide valuable insights into the reasoning of the machine learning model 216, making classification model more explainable.

In one example, machine learning model 216 may infer demographic characteristics (age, gender, location, etc.) of an author based on their tweets. A bag (data file) may contain all tweets by a single author. Each author may be represented as a separate bag. The tweets within a bag may be the instances. The labels (demographic characteristics) may be assigned to the entire bag (author), not to each individual tweet.

In another example, machine learning model 216 may be trained to verify the identity of an author based on a writing sample.

In this case a bag may contain a data file or multiple data files written by a potential author (can be the same or different authors for verification). Each data file/set of data files may be considered a bag.

Additionally, individual sentences or passages (textual excerpts) within the data file(s) may be the instances. The label (same author or different authors) may be assigned to the entire bag (data file or set of data files), not to each excerpt.

As noted above, in both of the aforementioned examples, machine learning model 216 may focus on analyzing the collection of data points (tweets or excerpts) within a bag to make inferences or predictions about the bag itself (author or data file). The annotation level may determine how the labels are applied. In author profiling, machine learning model 216 may assign the characteristics to the author (entire bag), while in verification, the label may indicate if all data files belong to the same author (entire bag). In an aspect, machine learning model 216 may utilize a technique called contrastive learning. Contrastive learning involves feeding the model pairs of text excerpts. These pairs may be: positive pairs (e.g. excerpts from the same author (e.g., two different chapters from the same book)) and negative pairs (e.g., excerpts from different authors (e.g., a chapter from one book and a news article from another author)). The machine learning model 216 may analyze these pairs. The contrastive learning technique may aim to: minimize the distance between embeddings of positive pairs (representing similar writing styles) and/or maximize the distance between embeddings of negative pairs (representing different styles). In the author profiling example, the machine learning model 216 may look for patterns and word usage within the tweets (instances) to infer the author's demographics (bag-level label). In an aspect, for verification, the machine learning model 216 may analyze the writing style and content of the excerpts (instances) from different data files (bags) to determine if they likely share the same author (data file-level label). In this example, machine learning model 216 may be trained on a large dataset of text documents where each document has a known author. During training, classification model may learn to identify stylistic features, vocabulary choices, and other characteristics unique to each author. These features may become like fingerprints that distinguish one author from another. The input document may be an unknown writing sample. The machine learning model 216 may not have seen the text of the document before, but machine learning model 216 may analyze stylistic features of the obtained document based on what machine learning model 216 learned during training. Based on the analyzed features, machine learning model 216 may predict the author who is most likely to have written the document. In an example, machine learning model 216 may output a probability score for each author in the training data (e.g., 70% chance of being written by Author A, 20% by Author B, 10% by Author C) or a single predicted author based on the highest probability.

Conventional approach may involve randomly selecting excerpts from the data file for further analysis.

In a non-limiting example, machine learning system 204 may actively select excerpts instead of random sampling. It should be noted that the excerpts remain unlabeled.

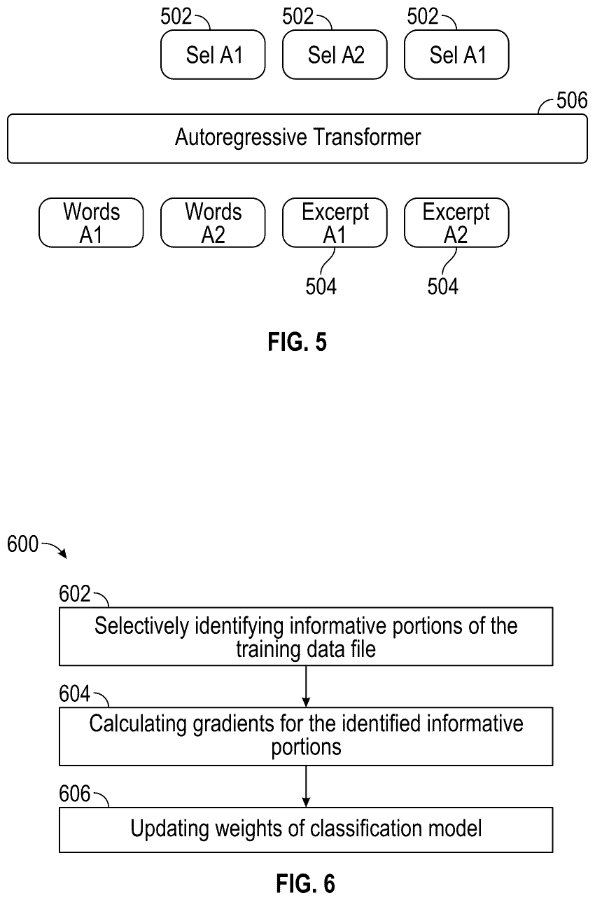

The machine learning system 204 may focus on identifying “extreme points” within the data file that are likely to be informative for classification purposes. The “extreme points” are data points that lie far away from the center of the data distribution and may be particularly informative for classification. An affine transformation is a mathematical function that can manipulate these data points. The affine transformation may be used on the features or representations of the data file to identify excerpts that deviate significantly from the “average” content, potentially indicating informativeness. The affline transformation may stretch or compress the data along certain dimensions, rotate the data in the embedding space, tilt the data, potentially revealing hidden patterns. A matrix W (k rows by embedding size) may be used to multiply the original data matrix X (embedding size by N, where N is the number of data points). This technique may effectively project the data onto a new space defined by W. After multiplication, the machine learning system 204 may select the highest scoring value (x) for each column in the resulting matrix. These top-scoring points may be considered the “extreme points.” Other techniques may generate the matrix based on features such as the presence of words or use a sequence model to select an excerpt and condition the selection of the next excerpt based on the previous selection, as described in greater detail below in conjunction with FIG. 5.

In an aspect, the generated matrix may comprise at least one of: a static matrix, conditionally generated matrix, conditionally executed matrix and an autoregressive sequence model. Static matrix may be a pre-defined matrix with fixed values. Static matrix would not change based on the specific document or situation. For example, a static matrix may comprise a pre-built table where rows represent documents and columns represent keywords. Each cell would have a value indicating the presence (1) or absence (0) of that keyword in a document. Conditionally generated matrix may be the matrix that is built based on some criteria. For example, the presence of specific words in the document may determine which values are included in the matrix. This allows for a more dynamic representation compared to a static matrix. Conditionally executed matrix is similar to conditionally generated, but instead of building the entire matrix, only relevant parts may be calculated based on the document. This could be useful for situations where memory is limited. Autoregressive sequence model may use a machine learning model to predict the next element in the matrix based on the previously chosen elements. This allows for highly dynamic and context-aware matrix creation.

Selecting informative excerpts directly may potentially improve the efficiency and accuracy of the classification process compared to random sampling.

As noted above, focusing on extreme points may help machine learning system 204 to identify excerpts that contain important information or unique aspects of the data file that are highly relevant to the classification task.

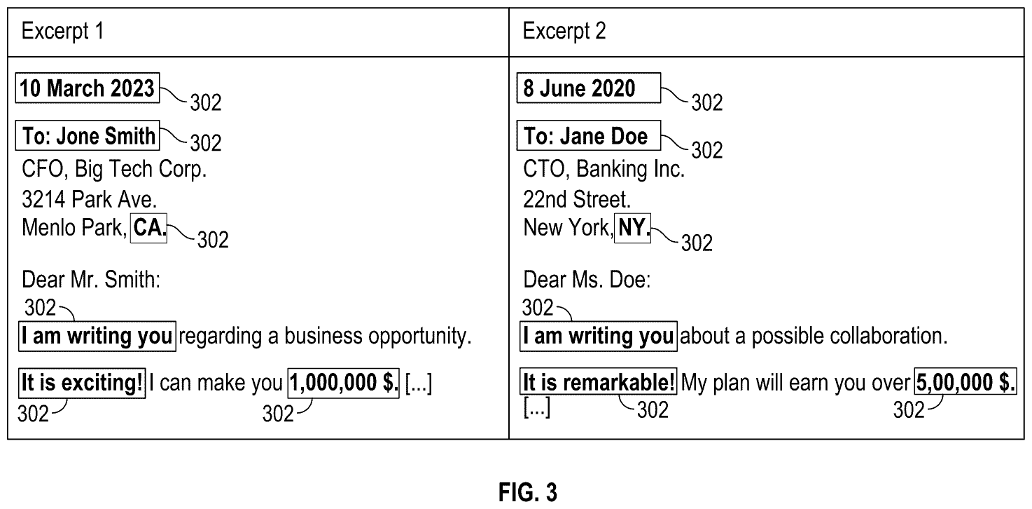

FIG. 3 illustrates selection of textual excerpts according to techniques of this disclosure.

Traditionally, analyzing a style of an author or identifying their work may often involve manually examining their writing. Such manual process may be time-consuming and subjective. While some techniques may use statistical analysis of word frequencies or stylistic features, such techniques may not be as nuanced or efficient. The disclosed techniques propose training machine learning model 216 to analyze a collection of texts by an author. The machine learning model 216 may then learn to identify representative passages that capture the essence of the writing style of the author. As noted above, traditionally, authorship verification may involve comparing entire data files written by different authors. Such authorship verification approach may be computationally expensive and less interpretable. By using selected textual excerpts 302 as the data points (instances) in a bag classification technique, several benefits may arise. In an example, the machine learning model 216 may focus on analyzing specific textual excerpts 302 that contribute most to the verification decision. In an example, the selected textual excerpts 302 may include, but are not limited to, sentences, phrases, keywords. Sentences with unique phrasing, vocabulary choices, or sentence structures could be good candidates. Specific word combinations or recurring stylistic elements could be informative. Words or themes that are particularly prominent in the known works of an author could be helpful as well. Words or phrases that appear more frequently in the known works of a particular author compared to a general corpus (collection of text) might be more informative. Sentences with unusual sentence structures, specific rhetorical devices (like metaphors or similes), or unique humor could be indicative of the style of the author. If the author is known for a particular subject area, sentences or phrases related to that topic may be more informative.

The techniques disclosed herein contemplate that the selected excerpts 302 may be examined to understand why machine learning model 216 classified the documents as belonging to the same or different authors. Instead of dealing with entire documents, focusing on key excerpts 302 reduces the amount of data to analyze. Such technique may be more manageable and efficient, especially when dealing with large data files.

When machine learning model 216 identifies documents as likely written by the same author (or not), machine learning model 216 may highlight the specific excerpts 302 that influenced the decision. In an example, such explainability may provide human experts with insights into the reasoning of the machine learning model 216 and may allow the human experts to evaluate accuracy of the machine learning model 216. Traditional neural networks are often referred to as “black boxes” because their internal decision-making process may be opaque and difficult to understand. If the neural network makes a wrong classification, it may be hard to pinpoint why the wrong classification happened. Without understanding the reasoning of the neural network, it may be difficult for humans to trust decisions of such neural networks, especially in critical applications like healthcare or finance. By understanding how the machine learning model 216 makes decisions, users may have more confidence in results generated by the machine learning model 216. Improved trust and reliability may be especially important in high-stakes domains. (continue here)

FIG. 4 is a conceptual diagram illustrating double pass max pooling, in accordance with the techniques of the disclosure. As shown in FIG. 4, the first phase 402 may be run by machine learning system 204 without gradients. Gradients are values used for training the model and can consume a lot of memory. By not calculating gradients in this phase, machine learning system 204 may save memory for processing the large data file.

The machine learning system 204 may process windows of tokenized text 404 as input.

Tokenization is the process of breaking down text into smaller units (tokens) like words or characters. Machine learning system 204 may divide the data file into smaller chunks of consecutive tokens (e.g., excerpts). In an example illustrated in FIG. 4, machine learning model 216 of the machine learning system 204 may include a pre-trained sentence embedding model 406, such as, but not limited to Multiple Instance Learning Bidirectional Encoder Representations from Transformers (MILBERT). In an example, MILBERT model 406 may focus on selecting informative excerpts from two documents suspected to be written by the same author. In authorship verification with contrastive learning, MILBERT model 406 may not necessarily focus on “extreme points” within a single document. Instead. MILBERT model 406 may aim to identify informative excerpts that best capture the author's writing style. This technique may be based on the idea that analyzing characteristic excerpts can be more efficient and informative than comparing entire documents. MILBERT model 406 may learn embeddings for each author based on the selected excerpts from their documents. This may involve identifying sections with unique vocabulary choices or sentence structures preferred by a first author and selecting excerpts that showcase first author's characteristic themes or arguments (if applicable). An embedding is a numerical representation that captures the essential characteristics of the writing style of the author. By comparing the author embeddings, the machine learning system 204 may determine how similar the writing styles are, potentially indicating if the documents share the same author. The MILBERT model 406 may generate numerical representations that capture the meaning of a sentence. The linear layer is a standard layer in neural networks that may perform a linear transformation on the input data.

Argmax is a function that selects the element with the highest value in a list. In an example, at the end of first stage 402, the machine learning system 204 may output the selected windows (excerpts) 408 from the data file.

In summary, during the first phase 402, the data file may be divided into windows of excerpts 404. Machine learning system 204 may pass each window through the MILBERT model 406, generating a numerical representation that captures the meaning of each window 404. The MILBERT output for each window may then be processed by a linear layer, and the linear layer may assign a score to each window based 404 on its informativeness for classification or authorship verification. Furthermore, machine learning system 204 may use the argmax function to select the windows 408 with the highest scores (most informative) as the excerpts to be used in the next phase 410.

In the second phase 410, machine learning system 204 may leverage the selected excerpts 408 for data file classification while enabling the machine learning model 216 to learn. The argmax function used in the first phase 402 to select excerpts 408 is not differentiable. Such non-differentiability may create a hurdle for backpropagation (the learning process) in machine learning model 216. To address the aforementioned non-differentiability, in the second phase 410 machine learning system 204 may replace argmax function with Gumbel-Softmax function 412. The Gumbel-Softmax function 412 is a differentiable approximation of the argmax function. Gumbel-Softmax function 412 may introduce a small amount of noise to the selection process, making it differentiable and allowing backpropagation to work effectively. During training, the machine learning system 204 may use the Gumbel-Softmax function 412 instead of argmax. This allows the machine learning model 216 to learn how to identify informative excerpts by backpropagating the errors through the selection process. Once the machine learning model 216 is trained, the argmax function may be used during evaluation, because argmax is more precise—and gives the exact index of the maximum value for selecting the most informative excerpt.

Gumbel-Softmax 412 is a technique that may create a differentiable approximation of a one-hot vector. Attention mechanisms are commonly used in neural networks to focus on specific parts of the input data most relevant to the task. Similar to attention, Gumbel-Softmax 412 in this context helps the machine learning system 204 focus exclusively on specific excerpts 408. Attention mechanisms typically assign weights (scores) to different parts of the input, but these weights remain as probabilities. Gumbel-Softmax 412, through its additional step, may transform the probability distribution into a one-hot attention vector. A one-hot vector is a binary vector where only one element has a value of 1, and all others are 0. By applying Gumbel-Softmax 412 in this specific way, the machine learning system 204 may essentially convert the probability distribution over excerpts 408 into a definitive selection for learning purposes.

In an example, a one-hot vector has all elements set to zero except for one position, which is set to one. This position may represent selection of a single element (like argmax). In an example, Gumbel-Softmax function 412 may allow the machine learning system 204 to assign “soft” probabilities to each excerpt 408 during selection, enabling the use of gradients for learning.

The selected windows (excerpts) 408 identified in the first phase 402 may be used as input for the second phase 410. Similar to the first phase 402, the sentence embedding model (e.g., MILBERT 406) may process each excerpt 408 to generate a numerical representation of its meaning. The Gumbel-Softmax function 412 may assign a soft score (probability) to each excerpt 408, indicating their relative importance for classification and allowing the machine learning model 216 to learn which excerpts 408 are most informative for classification. Excerpts 408 with their assigned scores may be fed into transformer layer 414. The transformer layer 414 may capture relationships and context between the excerpts 408 for more effective classification. In an example, the transformer layer 414 may have a specific weight matrix configuration. Transformer layers are a powerful architecture commonly used in data file classification tasks, particularly in natural language processing (NLP) tasks. The transformer layer 414 may not simply process each excerpt 408 in isolation. Transformer layer 414 may analyze the connections and context between them. Such analysis may consider several aspects, including, but not limited to: word order, co-occurrence, long range dependencies. Transformer layer 414 may consider the order in which excerpts 408 appear. For example, a specific phrase following another might be a stylistic hallmark of the author. Transformer layer 414 may identify how often excerpts 408 appear together within the data file. Frequent co-occurrence may indicate a thematic connection or stylistic pattern. Unlike traditional approaches, transformer layer 414 may capture long-range dependencies. In other words, transformer layer 414 may analyze how excerpts 408 further apart in the text may still be related through shared vocabulary or thematic elements. Additionally, the output from transformer layer 414 may go through final linear layer 416 to transform the data into a format suitable for the loss function.

The linear layer 416 may further process the output from the transformer layer 414. This linear layer 416 may essentially perform a weighted sum of the probabilities, for example, using learned weights 418 for each element in the vector. By design, the linear layer 416 and its weights may be trained to identify excerpts 408 with extreme probability values. These extreme points may represent excerpts 408 with the highest probabilities (most informative) or the lowest probabilities (potentially atypical or interesting for further analysis). In this context, the machine learning model 216 may focus on excerpts 408 that deviate significantly from the “average” content in the data file. These excerpts 408, considered extreme points, may hold valuable information for the task at hand. Depending on the specific classification task, machine learning system 204 may use either a contrastive loss function 418 or a classification loss function 420. Contrastive loss function 418 may be used when the machine learning model 216 needs to learn to distinguish similar or dissimilar data points. In this context, the contrastive loss 418 may help the machine learning model 216 differentiate between data files from different categories. Classification loss 420 is a more general loss function that may be used for tasks where the machine learning model 216 needs to predict a specific class label for the data file.

Machine learning system 204 may use this loss value to update the weights 214 of the machine learning model 216 through backpropagation in the learning process, as described above in conjunction with FIG. 2.

FIG. 5 is a conceptual diagram illustrating alterative informative excerpt selection strategies, in accordance with the techniques of the disclosure. In this example, the selection of excerpts may be conditioned on previous information in the form of a time-series model such as a Recurrent Neural Network (RNN) or a transformer. In the illustrated example, machine learning model 216 may process the document sequentially (like a time series), taking into account the order of the text. At each time-step, the machine learning model 216 may analyze the text seen so far (conditioned on previous information) emits a vector to be used to select an excerpt from the bag. This vector may represent the model's current understanding of the style of the author based on the processed text. The emitted vector may then be used to select an excerpt from the remaining text in the document (the “bag”). The selected excerpt may be considered informative based on the current context and the machine learning model's 216 understanding of the style of the author. Importantly, the selected excerpt becomes the next input for the time-series model. The aforementioned process may continue autoregressively, with the machine learning model 216 iteratively conditioning its selection on the previously chosen excerpts. Selectors 502 may be specialized modules within machine learning system 204 designed to identify informative excerpts 504 from text data. In one aspect, machine learning system 204 may employ a linear layer with stacked vectors (k-dimensional selection technique). This technique may utilize a linear layer to select k informative excerpts. Each excerpt may be represented by a vector. This vector may capture various stylistic features like word choice, sentence structure, or thematic elements relevant for authorship verification. The dimension of this vector refers to the number of features it encodes. The linear layer may take a stack of k vectors as input. Each vector in the stack may be associated with a potential excerpt. The linear layer may apply a weighted sum to these vectors. The weights may be learned during training. The k highest scoring excerpts (based on the weighted sum) may be chosen as informative. Each selector 502 may focus on different types of stylistic effects or “phenomena” present in the writing. Such specialization may allow the machine learning system 204 to capture a broader range of characteristics that contribute to a style of an author. As an analogy, a single fingerprint scanner may not capture the overall pattern, but for more robust identification, different scanners may be used that focus on specific details like ridges, loops, and whorls. Similarly, in an example, machine learning system 204 may use multiple selector components 502, each specializing in identifying different stylistic “fingerprints” within the writing of an author.

Another selection strategy may use the linear layer and the Gumbel-Softmax function 412. This technique builds upon the previously discussed Gumbel-Softmax function 412. A linear layer may be used similar to the first technique. A linear layer may take a stack of vectors representing potential excerpts. Instead of just choosing the top k, the machine learning system 204 may employ the Gumbel-Softmax function 412 to introduce noise and make the selection process differentiable. This may allow the machine learning model 216 to learn effectively during training with backpropagation. After applying Gumbel-Softmax function 412, the top k*L excerpts may be chosen. Here, L represents a scaling factor that can be adjusted to control the number of chosen excerpts. This noise may help machine learning model 216 to learn a soft selection over the options. As used herein, the term “soft selection” means machine learning model 216 may not choose a single option definitively. Instead, machine learning system 204 assigns a probability score to each option, indicating its likelihood of being informative. In an example, machine learning system 204 may employ Gumbel top k with higher consensus technique to create a k-hot embedding. In an example, this technique may build upon the idea of selecting top k excerpts using Gumbel-Softmax function 412. Furthermore, the higher consensus technique may focus on selecting more examples per dimension for the purpose of achieving higher consensus and potentially reducing redundancy. The term “dimension,” as used herein, refers to a factor by which excerpts are selected within the data file(s) that machine learning model 216 needs to consider. Dimensions may be realized as vectors. A matrix of k vectors has k dimensions. Selecting more excerpts per dimension may help machine learning model 216 to capture a broader range of information from each data file.

In yet another example, machine learning system 204 may utilize a decision tree-like structure for selection. Selector 502 may capture information complexity similar to a 3-dimensional selector, even though it only uses two selections (k=2). The machine learning system 204 may use a linear layer to generate a score for each potential excerpt. A decision tree may then be employed. The root node may compare the score to zero. If the score is negative, a pre-defined vector Sel_2 may be used to select an excerpt. If the score is positive, a different pre-defined vector Sel_3 may be used for selection. This effectively creates two selection paths based on the sign of the initial score, allowing for capturing some of the complexity of a 3-dimensional selector with a simpler structure.

In addition, machine learning system 204 may apply an autoregressive transformer technique illustrated in FIG. 5. This technique introduces a fundamentally different strategy for selecting excerpts. In an example, machine learning system 204 may utilize an autoregressive transformer, a powerful neural network architecture. The transformer model may process the document sequentially. At each time step, the transformer may emit a vector. This vector may represent the model's current understanding of the author's style based on the processed text so far. This emitted vector may be used to select an excerpt from the remaining text in the document. The autoregressive transformer 506 may iteratively select one excerpt at a time from each data file, for example, based on the previously selected excerpts and the emitted embeddings (numerical representations) by the machine learning model 216. The autoregressive transformer 506 may create a more dynamic selection process where the choice of the next excerpt may depend on the context established by the previously selected ones. For example, if the order of excerpts holds some stylistic significance, the autoregressive transformer 506 may be used to analyze these relationships while considering the order. The following example illustrates the dynamic selection process. The model might first choose an excerpt to determine if the article is even about math at all. If the machine learning model 216 identifies math content, it may then select an excerpt to determine the specific subfield (e.g., geometry). If no math content is found, the machine learning model 216 may shift its focus to a different subject area (e.g., computer science) If geometry content is identified, the machine learning model 216 may then select an excerpt to check for evidence of string algorithms, a specific topic within geometry. With no geometry, the machine learning model 216 could explore other subfields within math, and so on.

In summary, the Gumbel-Softmax top k technique may perform static selection of top k excerpts based on individual informativeness. The Gumbel top k with higher consensus technique may aim to capture a broader range of information and reduce redundancy by selecting more excerpts per dimension. The autoregressive transformer 506 may employ dynamic selection process where each excerpt choice considers the context established by previous selections. Gumbel top k with higher consensus technique may improve the ability of the machine learning model 216 to understand different aspects of the data file and reduce redundancy in the selected excerpts. The autoregressive transformer 506 may offer a more context-aware selection process, potentially leading to a more comprehensive understanding of the relationship between the excerpts and more discriminative power to select relevant excerpts.

FIG. 6 is a flowchart illustrating an example mode of operation for a machine learning system, according to techniques described in this disclosure. Although described with respect to computing system 200 of FIG. 2 having processing circuitry 243 that executes machine learning system 204, mode of operation 600 may be performed by a computing system with respect to other examples of machine learning systems described herein.

In mode of operation 600, processing circuitry 243 executes machine learning system 204. Machine learning model 204 may automatically selectively identify informative portions of one or more training data files (602). The term “automatically,” as used herein indicates that the identification of informative portions is done without human intervention. The machine learning system 204 may employ specific techniques described herein to perform the selection. Machine learning system 204 may obtain the training data file having an arbitrary size from file storage 120. In an example, the disclosed techniques may allow machine learning system 204 to scale data files of any size (arbitrary sized) according to a memory size constraint. The informative portions may be stored in a memory of a fixed size. In other words, the first step of the disclosed technique may efficiently identify informative excerpts (without calculating gradients) using a memory-saving approach. The model updates may be performed against training data that may be significantly larger than the predefined memory range. In other words, the entire training dataset does not need to be loaded into memory at once. The machine learning system 204 may process the training data in chunks (informative portions).

Next, machine learning system 204 may calculate gradients for the identified informative portions (604). In other words, this forward pass may be performed on the previously identified excerpts from the previous step, not the entire data file. Machine learning system 204 may also update weights 214 of machine learning model 216 using the calculated gradients (606). Machine learning system 204 may use a loss value to update the weights 214 of the machine learning model 216 through backpropagation in the learning process.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for training a Machine Learning (ML) model using arbitrarily sized training data files, to selectively identify informative portions of one or more training data files for improving the ML model, the method comprising:
automatically selectively identifying, by a computing system, one or more informative portions of one or more training data files;
calculating, by the computing system, gradients for the identified one or more informative portions; and
updating, by the computing system, weights of a ML model using the calculated gradients.

2. The method of claim 1, further comprising:
analyzing, by the computing system, exclusively the identified one or more informative portions to calculate the gradients.

3. The method of claim 1, wherein automatically selectively identifying the one or more portions further comprises: iteratively conditioning each selection on one or more previously chosen informative portions.

4. The method of claim 1,
wherein the training data file comprises a video file, and
wherein the identified one or more informative portions comprise one or more video clips.

5. The method of claim 1, wherein calculating gradients for the identified one or more informative portions comprises:
calculating the gradients based on a learning error of the classification model and based on an output of the classification model for the identified one or more informative portions.

6. The method of claim 1, wherein the classification model is trained to identify an identity of an author and wherein the training data file is a document.

7. The method of claim 6, wherein the identified one or more informative portions are selected so that the identified one or more informative portions are representative of a writing style of the author.

8. The method of claim 1,
wherein the ML model includes a transformer layer, and
wherein the transformer layer is trained to determine relationships and context between informative portions of training data files.

9. The method of claim 8, wherein the transformer layer comprises an autoregressive transformer.

10. The method of claim 1, wherein the one or more informative portions are stored and processed by the classification model using a portion of a memory according to a memory size constraint.

11. The method of claim 10, wherein the size of the training data files exceeds the size of the portion of the memory.

12. The method of claim 1, wherein the one or more informative portions are unlabeled.

13. The method of claim 1, further comprising:
generating a matrix based on one or more features of the training data files; and
wherein automatically selectively identifying the one or more informative portions of one or more training data files further comprises automatically selectively identifying the one or more informative portions using the generated matrix.

14. The method of claim 13, wherein the generated matrix comprises one of: a static matrix, conditionally generated matrix, or conditionally executed matrix.

15. A method for classifying data files, the method comprising:
obtaining one or more arbitrarily sized data files; and
classifying the one or more arbitrarily sized data files using a classification model trained to classify arbitrarily sized data files according to a memory size constraint.

16. The method of claim 15, wherein the one or more arbitrarily sized data files comprise one or more collections of data files.

17. A computing system for training a Machine Learning (ML) model, using arbitrarily sized training data files, to selectively identify informative portions of one or more training data files for improving the ML model, the computing system comprising:
processing circuitry in communication with storage media, the processing circuitry configured to execute a machine learning system configured to:
automatically selectively identify one or more informative portions of one or more training data files;
calculate gradients for the identified one or more informative portions; and
update weights of a ML model using the calculated gradients.

18. The system of claim 17, wherein the machine learning system is further configured to:
analyze exclusively the identified one or more informative portions to calculate the gradients.

19. The system of claim 17, wherein the machine learning system configured to automatically selectively identify the one or more portions is further configured to:
iteratively condition each selection on one or more previously chosen informative portions.

20. Non-transitory computer-readable storage media having instructions encoded thereon, the instructions configured to cause processing circuitry to:
automatically selectively identify one or more informative portions of one or more training data files;
calculate gradients for the identified one or more informative portions; and
update weights of a machine learning model using the calculated gradients.
